(19) United States
(12) Patent Application Publication
(10) Pub. No.: US 2021/0127885 A1
(43) Pub. Date: May 6, 2021

(54) SEAL ARRANGEMENT FOR COOKING APPARATUS

(71) Applicant: BJB GmbH & Co. KG, Amsberg (DE)

(72) Inventors: Olaf Baumeister, Sundern (DE); Joerg Harnischmacher, Menden (DE)

(21) Appl. No.: 17/002,551

(22) Filed: Aug. 25, 2020

(30) Foreign Application Priority Data
Nov. 6, 2019 (DE) DE202019106167.7

(51) Int. Cl. A47J 27/00

(52) U.S. Cl. CPC A47J 27/002

(57) ABSTRACT

A seal arrangement for a cooking apparatus, the seal arrangement comprising: a cooking cavity wall with an opening configured to be sealed by the seal arrangement and configured as a pass through for an illuminant configured as a translucent rod with an essentially circular cylindrical shape; a housing element that is sealed relative to an outside of the cooking cavity wall by a first seal and that includes a receiver for a second seal that seals the housing element relative to the illuminant; retaining elements which arrange the housing element at the outside of the cooking cavity wall, wherein the second seal is a graphite ring, and wherein the illuminant is arrangeable within an annular cavity of the graphite ring.

### RELATED APPLICATIONS

This application claims priority from and incorporates by reference German utility model DE 20 2019 106 167.7, filed on Nov. 6, 2019.

### FIELD OF THE INVENTION

The invention relates to a seal arrangement for a cooking apparatus like an oven, a steam cooker or a microwave.

### BACKGROUND OF THE INVENTION

Seal arrangements are well known in the art. They are used in a great variety of cooking apparatuses, in particular ovens, steam cookers or microwaves in order to prevent vapors generated during the cooking of food products from passing through the illuminant openings of the cooking cavity wall into an equipment cavity arranged behind the cooking cavity wall.

An increasing use of LED illuminants for illuminating cooking cavities leads to an increased use of light conductors which conduct light emitted by the LED into the cooking cavity. Thus, typically glass rods or rods from temperature resistant synthetic materials are being used. This has the substantial advantage that temperature sensitive LED light sources can be arranged far away from the heated cooking cavity.

The light conductor rods extend through openings in the cooking cavity wall that have to be sealed against a pass through of vapors.

### BRIEF SUMMARY OF THE INVENTION

Thus, it is an object of the invention to provide an advantageous seal arrangement. The object is achieved by a seal arrangement for a cooking apparatus, the seal arrangement including a cooking cavity wall with an opening configured to be sealed by the seal arrangement and configured as a pass through for an illuminant configured as a translucent rod with an essentially circular cylindrical shape; a housing element that is sealed relative to an outside of the cooking cavity wall by a first seal and that includes a receiver for a second seal that seals the housing element relative to the illuminant; retaining elements which arrange the housing element at the outside of the cooking cavity wall, wherein the second seal is a graphite ring, and wherein the illuminant is arrangeable within an annular cavity of the graphite ring. Advantageous embodiments are included in the dependent claims.

### BRIEF DESCRIPTION OF THE DRAWINGS

The invention is now described based on an embodiment with reference to drawing figures, wherein

FIG. 1 illustrates an exploded view of the seal arrangement according to the invention; and

FIG. 2 illustrates the seal arrangement according to FIG. 1 in a sectional view in an installed condition.

### DETAILED DESCRIPTION OF THE INVENTION

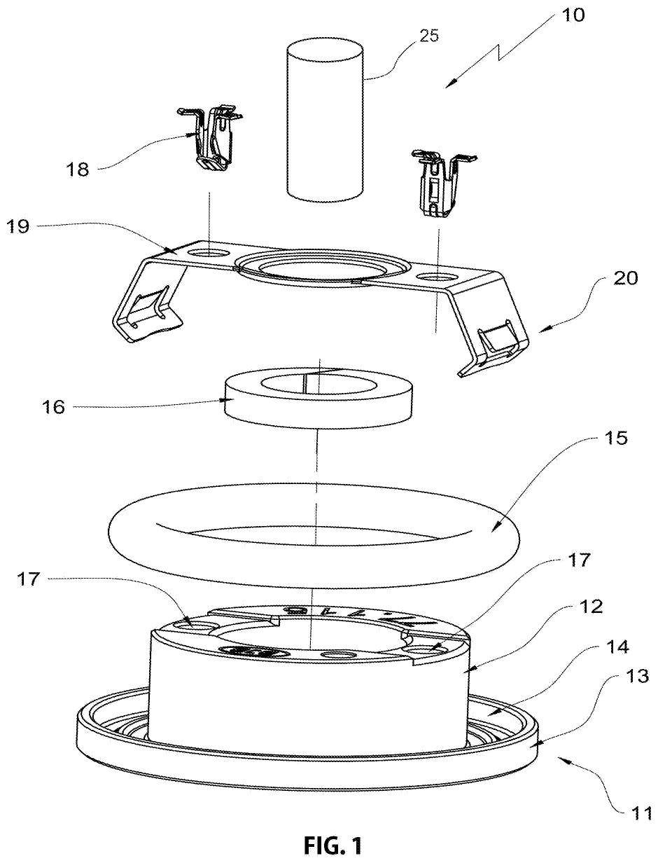

In the drawing figures the seal arrangement according to the invention is designated over all with reference numeral 10. Components of the seal arrangement are evident in particular from the exploded view in FIG. 1. The seal arrangement includes a housing element 11 with a circular cylindrical base element 12 that forms a circumferentially expanded collar 13 at a first end. The collar 13 forms an annular groove 14 that is open towards a free end of the base element 12. The annular groove 14 receives a first seal configured as an annular seal 15.

The base element 12 includes a receiver for a seal ring 16 at an end that is oriented away from the collar 13. Furthermore the base element includes attachment recesses 17 that are engaged by support devices 18 configured to attach a support clamp 19 at the base element 12. Ends 20 of the support clamp 19 are configured spring elastic.

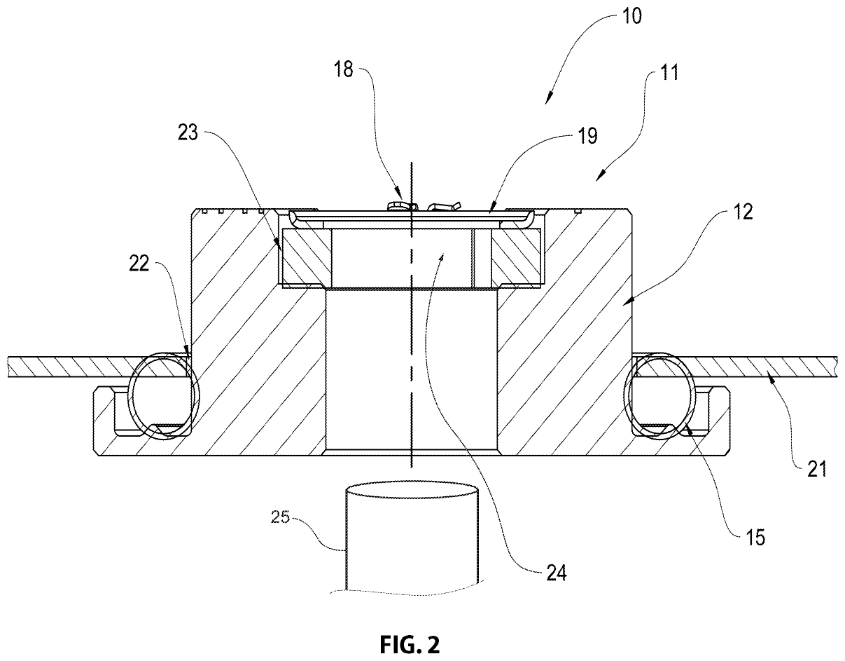

FIG. 2 illustrates a sectional view of the installed configuration of the seal arrangement according to FIG. 1. In addition to FIG. 1, FIG. 2 illustrates a portion of a cooking cavity wall 21 that includes an opening 22 for passing an illuminate through, in particular a rod shaped cylindrical light conductor 25 in particular a glass rod or synthetic material rod.

The seal arrangement 10 is inserted the opening 22 wherein the base element 12 is supported in the opening 22. The collar 13 is placed against the cooking cavity wall 21 on a cooking cavity side so that the annular seal 15 seals on the one hand side against the collar 13 and on the other hand side against the cooking cavity wall 21. Thus, a pass through of vapors between the base element 12 and the cooking cavity wall 21 is reliably prevented.

The sectional view according to FIG. 2 illustrates the seal receiver 23 as a recess that is circumferentially expanded relative to the annular cavity 24 of the base element. The seal ring 16 is inserted into the seal receiver 23. The seal ring 16 seals on the one hand side relative to the base element 12 and on the other hand side relative to a light conductor rod that passes through the seal ring 16 and that is supported in the annular cavity 24 of the base element 12. The housing element 11 is supported by the retaining clamp 19 at the cooking cavity wall 21. Thus, the spring elastic ends 20 of the retaining clamp 19 are supported at an outer surface of the cooking cavity wall 21 that is oriented away from the cooking cavity. The spring reset forces preload the collar 13 against the cooking cavity wall and provide for a sealing contact of the annular seal 15.

The seal ring 16 that seals relative to the light conducting rod is made from a suitable seal material. In a particularly advantageous embodiment of the invention, this seal material is graphite. The graphite is advantageously adapted to a thermal expansion coefficient of the light conducting rod. Advantageously the light conducting rod and the graphite ring have a substantially identical thermal expansion coefficient. Particularly advantageously the graphite ring has a thermal expansion coefficient that is slightly higher than a thermal expansion coefficient of the light conducting rod. The higher thermal expansion coefficient of the graphite ring causes it to expand more in three dimensions than the light conducting rod when the temperature increases. This causes a sealing closure between the seal ring 16 and the light conductor rod.

A corresponding sealing closure can also be achieved in that the seal ring 16 is fabricated e.g. with a slight undersize relative to the light conducting rod. In this case it is particularly advantageous when the seal ring 16 is cut along a cut line. This provides that the seal ring 16 can expand slightly when the light conducting rod is inserted into the annular cavity 24 of the base element or into the annular cavity of the seal ring 16.

When the section line along which the graphite ring is cut open encloses an angle of greater than 0° with a radial line of the seal ring 16, this improves sealing performance. A corresponding angular arrangement of the section line makes a vapor transition through a possible gap more difficult. An angle between 40° and 50° relative to the radial line, in particular 45° relative to the radial line is considered ideal.

When the thermal expansion coefficient ratios are selected as recited supra it is conceivable to configure the seal ring 16 so that a possible cut or separation gap is closed by the material expansion under heat impact.

Since friction between graphite and a light conducting rod, in particular a light conducting rod made from glass is very small, leak tightness of the seal ring relative to the light conducting rod can also be established by an annular cavity diameter of the seal ring 16 and a diameter of the glass rod having identical dimensions. However, is it also conceivable that the seal ring 16 is fabricated with a slight oversize relative to the light conducting rod to be inserted. In view of the ratios of the thermal expansion coefficients this oversize can still provide sealing contact since the sealing closure between the seal ring 16 and the light conducting rod can be established by thermal expansion.

### REFERENCE NUMERALS AND DESIGNATIONS

10 seal arrangement
11 housing element
12 base element
13 collar
14 annular groove
15 annular seal
16 seal ring
17 attachment recess
18 retaining device
19 retaining clamp
20 end of 19
21 cooking cavity wall
22 opening
23 seal receiver
24 annular cavity
25 illuminant

What is claimed is:

1. A seal arrangement for a cooking apparatus, the seal arrangement comprising:
a cooking cavity wall with an opening configured to be sealed by the seal arrangement and configured as a pass through for an illuminant configured as a translucent rod with an essentially circular cylindrical shape;
a housing element that is sealed relative to an outside of the cooking cavity wall by a first seal and that includes a receiver for a second seal that seals the housing element relative to the illuminant;
retaining elements which arrange the housing element at the outside of the cooking cavity wall,
wherein the second seal is a graphite ring, and
wherein the illuminant is arrangeable within an annular cavity of the graphite ring.

2. The seal arrangement according to claim 1, wherein graphite ring is cut along a cut line.

3. The seal arrangement according to claim 2,
wherein the cut line is oriented at an angle greater than 0° and up 45° to relative to a radial line of the seal ring.

4. The seal arrangement according to claim 1, wherein the seal ring is fabricated with under size, over size or identical size relative to a circumferential contour of the illuminant that is arrangeable within the seal ring.

5. The seal arrangement according to claim 1, wherein a thermal expansion coefficient of the seal ring is substantially identical to a thermal expansion coefficient of the illuminant or greater than the thermal expansion coefficient of the illuminant.
